(19) United States
(12) Patent Application Publication
(10) Pub. No.: US 2010/0326729 A1
(43) Pub. Date: Dec. 30, 2010

(54) CASING BITS, DRILLING ASSEMBLIES, AND METHODS FOR USE IN FORMING WELLBORES WITH EXPANDABLE CASING

(75) Inventors: Timothy K. Marvel, The Woodlands, TX (US); Matthew J. Meiners, Conroe, TX (US); John G. Evans, The Woodlands, TX (US)

Correspondence Address: Traskbritt, P.C. / Baker Hughes, Inc.;Baker Hughes, Inc., P.O. Box 2550, Salt Lake City, UT, 84110, US

(73) Assignee: BAKER HUGHES INCORPORATED, Houston, TX (US)

(21) Appl. No.: 12/771,504

(22) Filed: Apr. 30, 2010

Related U.S. Application Data
(60) Provisional application No. 61/174,825, filed on May 1, 2009.

(51) Int. Cl. E21B 7/00; E21B 17/14; E21B 17/10; B21K 5/04; B23P 11/00

(52) U.S. Cl. 175/57; 175/402; 175/230; 76/108.1; 29/428

(57) ABSTRACT

Casing bits include an expander for enlarging an inner diameter of expandable casing at least partially disposed within a body of the casing bits. Drilling assemblies include a casing bit attached to an end of expandable casing, and an expander disposed in proximity to the casing bit and a distal end of the expandable casing. Methods of forming casing bits include positioning an expander in proximity to a body of a casing bit. Methods of forming drilling assemblies include positioning an expander in proximity to a body of a casing bit and a distal end of expandable casing, and attaching the casing bit to the end of the expandable casing. Methods of casing a wellbore include one or both of drilling and reaming a wellbore using a casing bit attached to a distal end of expandable casing, and forcing an expander through the expandable casing.

### CROSS-REFERENCE TO RELATED APPLICATIONS

The present application claims the benefit of U.S. Provisional Patent Application Ser. No. 61/174,825, filed May 1, 2009 and entitled “Casing Bits, Drilling Assemblies, and Methods for Use In Forming Wellbores With Expandable Casing,” the disclosure of which is incorporated herein by reference in its entirety.

### TECHNICAL FIELD

Embodiments of the present invention relate to casing bits, drilling assemblies, and methods that may be used to form wellbores using expandable casing.

### BACKGROUND

Wellbores are formed in subterranean formations for various purposes including, for example, extraction of oil and gas from the subterranean formation and extraction of geothermal heat from the subterranean formation. A wellbore may be formed in a subterranean formation using a drill bit such as, for example, an earth-boring rotary drill bit. Different types of earth-boring rotary drill bits are known in the art including, for example, fixed-cutter bits (which are often referred to in the art as “drag” bits), rolling-cutter bits (which are often referred to in the art as “rock” bits), diamond-impregnated bits, and hybrid bits (which may include, for example, both fixed cutters and rolling cutters). The drill bit is rotated and advanced into the subterranean formation. As the drill bit rotates, the cutters or abrasive structures thereof cut, crush, shear, and/or abrade away the formation material to form the wellbore. A diameter of the wellbore drilled by the drill bit may be defined by the cutting structures disposed at the largest outer diameter of the drill bit.

The drill bit is coupled, either directly or indirectly, to an end of what is referred to in the art as a “drill string,” which comprises a series of elongated tubular segments connected end-to-end that extends into the wellbore from the surface of the formation. Various tools and components, including the drill bit, may be coupled together at the distal end of the drill string at the bottom of the wellbore being drilled. This assembly of tools and components is referred to in the art as a “bottom hole assembly” (BHA).

The drill bit may be rotated within the wellbore by rotating the drill string from the surface of the formation, or the drill bit may be rotated by coupling the drill bit to a downhole motor, which is also coupled to the drill string and disposed proximate the bottom of the wellbore. The downhole motor may comprise, for example, a hydraulic Moineau-type motor having a shaft, to which the drill bit is mounted, that may be caused to rotate by pumping fluid (e.g., drilling mud or fluid) from the surface of the formation down through the center of the drill string, through the hydraulic motor, out from nozzles in the drill bit, and back up to the surface of the formation through the annular space between the outer surface of the drill string and the exposed surface of the formation within the wellbore.

It is known in the art to use what are referred to in the art as a “reamer” devices (also referred to in the art as “hole opening devices” or “hole openers”) in conjunction with a drill bit as part of a bottom hole assembly when drilling a wellbore in a subterranean formation. In such a configuration, the drill bit operates as a “pilot” bit to form a pilot bore in the subterranean formation. As the drill bit and bottom hole assembly advances into the formation, the reamer device follows the drill bit through the pilot bore and enlarges the diameter of, or “reams,” the pilot bore.

After drilling a wellbore in a subterranean earth-formation, it may be desirable to line the wellbore with sections of casing or liner. Casing is relatively large diameter pipe (relative to the diameter of the drill pipe of the drill string used to drill a particular wellbore) that is assembled by coupling casing sections in an end-to-end configuration. Casing is inserted into a previously drilled wellbore, and is used to seal the walls of the subterranean formations within the wellbore. The casing then may be perforated at one or more selected locations within the wellbore to provide fluid communication between the subterranean formation and the interior of the wellbore. Casing may be cemented in place within the wellbore. The term “liner” refers to casing that does not extend to the top of a wellbore, but instead is anchored or suspended from inside the bottom of another casing string or section previously placed within the wellbore. As used herein, the terms “casing” and “casing string” each include both casing and liner, and strings respectively comprising sections of casing and liner.

As casing is advanced into a wellbore, it is known in the art to secure a cap structure to the distal end of the distal casing section in the casing string (the leading end of the casing string as it is advanced into the wellbore). As used herein, the term “distal” means distal to the earth surface into which the wellbore extends (i.e., the end of the wellbore at the surface), while the term “proximal” means proximal to the earth surface into which the wellbore extends. The casing string, with the casing bit attached thereto, optionally may be rotated as the casing is advanced into the wellbore. In some instances, the cap structure may be configured as what is referred to in the art as a casing “shoe”, which is primarily configured to guide the casing into the wellbore and ensure that no obstructions or debris are in the path of the casing, and to ensure that no debris is allowed to enter the interior of the casing as the casing is advanced into the wellbore. The “shoe” may conventionally contain a check valve, termed a “float valve,” to prevent fluid in the wellbore from entering the casing from the bottom, yet permit cement to be subsequently pumped down into the casing, out the bottom through the shoe, and into the wellbore annulus to cement the casing in the wellbore.

In other instances, the casing cap structure may be configured as a reaming bit or “shoe,” which serves the same purposes of a casing shoe, but is further configured for reaming (i.e., enlarging) the diameter of an existing wellbore as the casing is advanced into the wellbore. It is also known to employ drill bits configured to be secured to the distal end of a casing string for drilling a wellbore. Drilling a wellbore with such a drill bit attached to casing is referred to in the art as “drilling with casing.” Such reaming bits or shoes, as well as such drill bits, may be configured and employ materials in their structures to enable subsequent drilling therethrough from within using a drill bit run down the casing or liner string. As used herein, the term “casing bit” means and includes such casing bits as well as such reaming bits and shoes configured for attachment to a distal end of casing as the casing is advanced into a wellbore.

### BRIEF SUMMARY

In some embodiments, the present invention includes casing bits having a body and at least one cutting structure on an outer surface of the body. The casing bits further include an expander at least partially disposed within the body. The expander is sized and configured to expand expandable casing to which the casing bit is secured as the expander is forced longitudinally through the expandable casing.

In additional embodiments, the present invention includes drilling assemblies having a casing bit attached to an end of at least one section of expandable casing. The casing bit has a body and at least one cutting structure on an outer surface of the body. An expander is disposed within at least one of the casing bit and the end of the section of expandable casing. The expander is sized and configured to expand expandable casing as the expander is forced longitudinally through the expandable casing.

In additional embodiments, the present invention includes methods of forming casing bits. To form a casing bit, an expander may be configured to enlarge at least an inner diameter of expandable casing as the expander is forced through the expandable casing, and the expander may be positioned at least partially within a body of the casing bit.

In additional embodiments, the present invention includes methods of forming drilling assemblies. In accordance with such methods, an expander may be positioned within at least one of a body of a casing bit and an adjacent end of a section of expandable casing, and the body of the casing bit may be attached to the end of the section of expandable casing. The expander may be configured to enlarge at least an inner diameter of expandable casing as the expander is forced through the expandable casing.

Yet further embodiments of the present invention include methods of casing a wellbore. A wellbore may be drilled and/or reamed using a casing bit attached to a distal end of at least one section of expandable casing. An expander disposed within at least one of the casing bit and the distal end of the section of expandable casing may be forced longitudinally through the section of expandable casing in a proximal direction. As the expander is forced through the expandable casing, at least an inner diameter of the expandable casing may be enlarged.

### BRIEF DESCRIPTION OF THE DRAWINGS

FIGS. 1A through 1F are simplified, schematic cross-sectional views of a wellbore and equipment therein illustrating a method that may be used to drill a wellbore using a casing bit on expandable casing, and subsequently expanding the expandable casing within the wellbore;

FIG. 2 is a simplified cross-sectional view of an embodiment of a casing bit of the present invention;

FIG. 3 is a simplified cross-sectional view of another embodiment of a casing bit of the present invention;

FIG. 4 is a side view of an embodiment of an outer body of a casing bit of the present invention; and

FIG. 5 is a side view of another embodiment of an outer body of a casing bit of the present invention.

### DETAILED DESCRIPTION

The illustrations presented herein are not actual views of any particular drilling system, drilling tool assembly, or component of such an assembly, but are merely idealized representations which are employed to describe the present invention.

Embodiments of the present invention may be used to drill or ream a wellbore with expandable casing using a casing bit attached to the expandable casing, and to subsequently expand (i.e., enlarge at least an inner diameter of) the expandable casing without tripping the casing bit out from the wellbore.

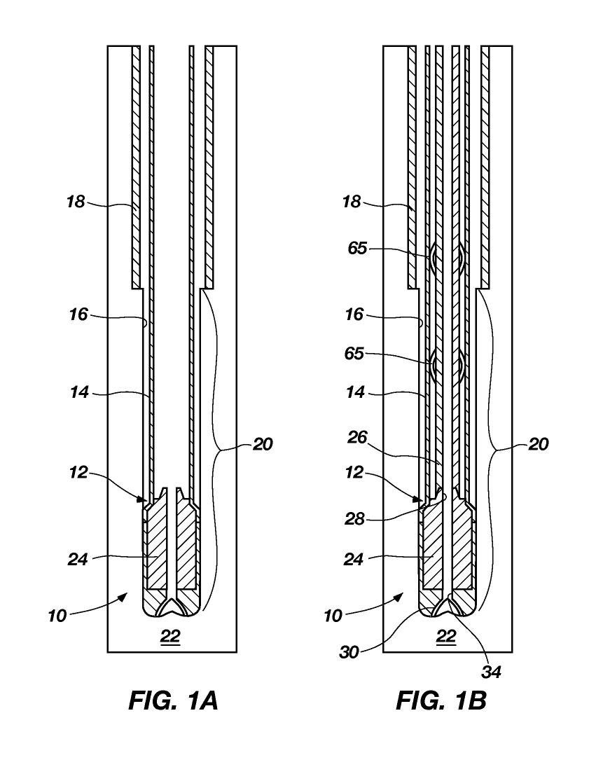

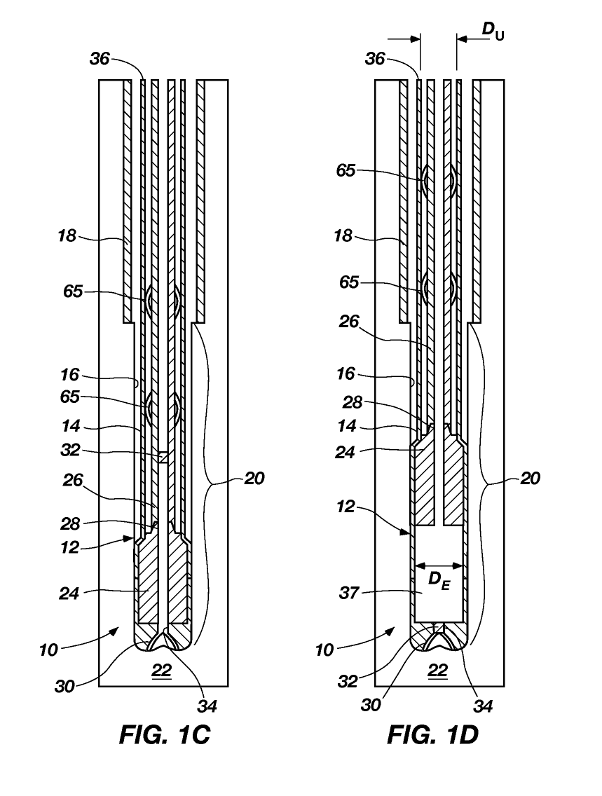

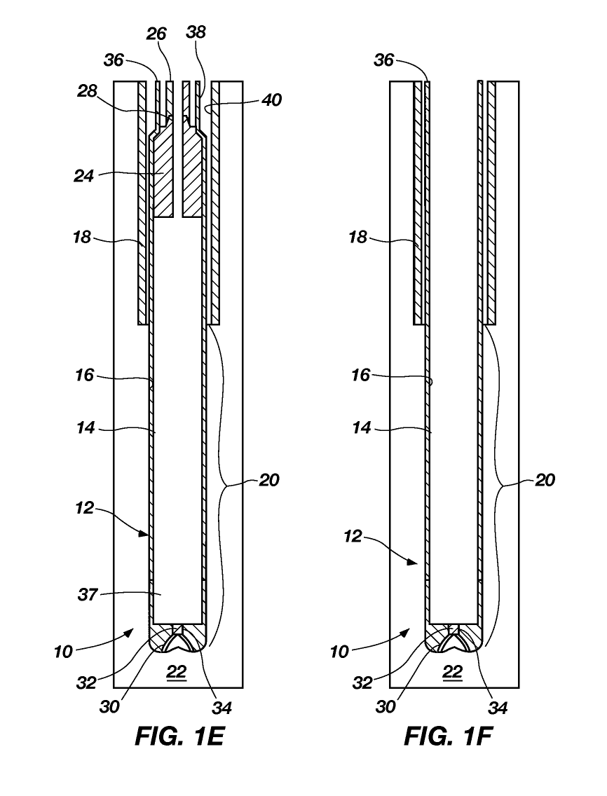

An embodiment of a method of the present invention that may be used to form or enlarge at least a section of a wellbore and position casing within the section of the wellbore is described below with reference to FIGS. 1A through 1F.

Referring to FIG. 1A, a drilling assembly may be provided that includes a casing bit 10 attached to a distal end 12 of expandable casing 14. The expandable casing 14 with the casing bit 10 thereon may be advanced into a previously drilled wellbore 16. As discussed in further detail below with reference to FIG. 4, the casing bit 10 may comprise one or more cutting structures configured for at least one of reaming and drilling a wellbore 16. The cutting structure or structures may comprise any conventional abrasive or superabrasive material suitable for removing material from the particular formation being reamed or drilled. In some embodiments, at least a portion of the wellbore 16 may have been lined with additional casing 18 prior to advancing the expandable casing 14 into the wellbore 16. The expandable casing 14 may be advanced into the wellbore 16 until the casing bit 10 is positioned at the bottom of the previously drilled section of the wellbore 16. The expandable casing 14 and the casing bit 10 attached to the distal end 12 of the expandable casing 14 then may be rotated within the wellbore 16 as axial force, termed “weight on bit” (WOB), is applied to the expandable casing 14 and the casing bit 10 to cause the casing bit 10 to drill an additional section 20 of the wellbore 16 into the subterranean formation 22.

The drilling assembly may be rotated within the wellbore 16 by rotating the expandable casing 14 from the surface of the formation, or the drilling assembly may be rotated by coupling the expandable casing 14 to a downhole motor. The motor also may be coupled to a drill string and disposed within the wellbore 16. The downhole motor may comprise, for example, a hydraulic Moineau-type motor having a shaft, to which the expandable casing 14 is attached. The drive shaft and the expandable casing 14 may be caused to rotate by pumping fluid (e.g., drilling mud or fluid) from the surface of the formation down through the center of the drill string, through the hydraulic motor, through the expandable casing 14, through the casing bit 10, out through fluid passageways extending through the casing bit, and back up to the surface of the formation through the annular space between the outer surface of the expandable casing 14 and the exposed surface of the formation within the wellbore 16.

With continued reference to FIG. 1A, the drilling assembly further includes an expander 24 that may be disposed within and attached to at least one of the casing bit 10 and the expandable casing 14 at a location proximate the distal end 12 of the expandable casing 14. The expander 24 is sized and configured to expand the diameter of the expandable casing 14 as the expander 24 is forced longitudinally through the interior of the expandable casing 14. By way of example and not limitation, the expander 24 may be a generally cylindrical, tubular member. A fluid passageway may extend longitudinally through the length of the expander 24. A tapered, frustoconical surface may be provided on a proximal end of the expander 24 to facilitate the smooth, gradual expansion of the expandable casing 14 as the expander 24 is forced through the casing 14. The expander 24 may comprise, for example, a metal alloy exhibiting a yield strength sufficiently high that the expander 24 will not undergo any significant plastic deformation, and sufficiently low elastic deformation to allow complete expansion of the expandable casing 14, as the expander 24 is forced longitudinally through the expandable casing 14.

In some embodiments, the expander 24 initially may be partially disposed within an interior region of the casing bit 10, and partially within an interior region of the distal end 12 of the expandable casing 14. In additional embodiments, the expander 24 initially may be entirely disposed within an interior region of the casing bit 10, or entirely within an interior region of the distal end 12 of the expandable casing 14.

The expandable casing 14 may comprise a metal alloy having a material composition selected to allow the expandable casing 14 to expand plastically as the expander 24 is forced therethrough. The ultimate strength of the material of the expandable casing 14 should be sufficiently high to prevent the expandable casing 14 from rupturing as the expander 24 is forced through the expandable casing 14.

After drilling an additional section 20 of the wellbore 16 using the casing bit 10, a liquid cement or other hardenable material may be pumped through the expandable casing 14, and out from the casing bit 10 through fluid passageways 30 extending therethrough, into the annulus between the formation and the casing. The cement or other hardenable material may have a composition selected to harden only after expansion of the expandable casing 14, as described below. The volume of cement pumped into the annulus may be selected to fill the ultimate volume of the annulus that will be present after expansion of the expandable casing 14. Initially, when such a volume of cement is pumped into the annulus, it may not surround the casing 14 along the entire length thereof. Upon expansion of the expandable casing 14, however, the expanding casing 14 may squeegee the cement along the length of the casing 14 to surround the expanded casing 14 along substantially the entire length thereof. The cement may be allowed to solidify within the annular space after expansion of the casing 14, thereby affixing the expandable casing 14 in place within the wellbore 16.

Referring to FIG. 1B, a pipeline 26 (e.g., a drill string, coiled tubing, a parasitic string, etc.) may be advanced through the interior of the expandable casing 14 and attached to the expander 24. One or more centralizer devices 65 such as, for example, centralizer springs, may be used to position (e.g., center) the pipeline 26 within the expandable casing 14. By way of example and not limitation, a threaded pin 28 may be provided on a proximal end of the expander 24. The threaded pin 28 may be configured to matingly engage a threaded box on a distal end of the pipeline 26. Thus, the pipeline 26 may be rotated to thread the distal end of the pipeline 26 onto the threaded pin 28 on the expander 24. Of course, a threaded box may be used on a proximal end of the expander 24, and a threaded pin on the distal end of the pipeline 26. In additional embodiments, mechanical attachment between the pipeline 26 and the expander 24 may be obtained using other connection configurations known in the art that require little or no relative rotation between the pipeline and the expander 24. Many such connections are known in the art and may be employed in embodiments of the present invention. Some such connections are referred to in the art as mechanical “stingers,” and include complementary male and female connection portions (one being provided on the pipeline 26 and the other on the expander 24) that mechanically interlock with one another upon insertion of the male connector into the female connector.

In additional embodiments of the invention, the pipeline 26 (or another type of string) may be attached to the expander 24 prior to drilling the additional section 20 of the wellbore 16 with the casing bit 10 and expandable casing 14.

Referring to FIG. 1C, fluid passageways 30 extending through the casing bit 10 may be plugged. By way of example and not limitation, a plug 32 (e.g., an elongated body, a generally spherical ball, or a dart) may be pumped down through the pipeline 26, through the expander 24, and into a receptacle 34 in the casing bit 10 configured to receive the plug 32, in the manner of a float plug engaging a float shoe. The receptacle 34 may be configured to lockingly engage, and retain therein, the plug 32 to prevent backflow into expandable casing 14 from the wellbore. The casing bit 10 may be configured such that fluid flow through the fluid passageways 30 in the casing bit 10 is interrupted when the plug 32 is disposed and seated within the receptacle 34.

Referring to FIG. 1D, the expander 24 may be forced longitudinally through the expandable casing 14 from the distal end 12 thereof toward a proximal end 36 thereof. The expander 24 may be forced through the expandable casing 14 by pulling the expander 24 through the expandable casing 14 using the pipeline 26 (i.e., by mechanical force), by pumping hydraulic fluid down through the pipeline 26 and into a space 37 distal to the expander 24 at relatively high pressure such that the hydraulic pressure distal to the expander 24 forces the expander 24 through the expandable casing 14 in the proximal direction (i.e., by hydraulic pressure), or by a combination of such methods (i.e., by a combination of mechanical force and hydraulic pressure).

FIG. 1D illustrates the expander 24 at a relatively lower intermediate location within the expandable casing 14. As shown in FIG. 1D, the section of the expandable casing 14 distal to the expander 24 has a relatively larger expanded inner diameter D_{E}, while the section of the expandable casing 14 proximal to the expander 24 has a relatively smaller unexpanded inner diameter D_{U}. In some embodiments, D_{E} may be about 105% or more of D_{U}. In additional embodiments, D_{E} may be about 110% or more of D_{U}, or even about 120% or more of D_{U}.

As the inner diameter of the expandable casing 14 is expanded from D_{U} to D_{E}, the overall length of the expandable casing 14 may decrease, the wall thickness of the expandable casing 14 may decrease, or both the overall length and the wall thickness of the expandable casing 14 may decrease. Thus, a desirable final length and a desirable final wall thickness may be considered together with the degree to which the overall length and the wall thickness of the expandable casing 14 decrease upon expansion thereof by the expander 24 when designing an initial, unexpanded section of expandable casing 14 for a particular application.

FIG. 1E is similar to FIG. 1D, but illustrates the expander 24 at a relatively higher intermediate location within the expandable casing 14.

FIG. 1F illustrates the expandable casing 14 after the expander 24 has been passed entirely through the expandable casing 14, such that the entire length of the casing 14 has been expanded from the relatively smaller unexpanded inner diameter D_{U} to the relatively larger expanded inner diameter D_{E}, and the expander 24 has been removed from the wellbore 16. Upon expansion of the proximal end 36 of the expandable casing 14, the outer surface 38 of the expandable casing 14 at the proximal end 36 thereof may be forced against an inner surface 40 of a previously placed section of additional casing 18. Optionally, one or more sealing materials may be provided between the outer surface 38 of the expandable casing 14 and the inner surface 40 of the additional casing 18 to ensure that an adequate seal results therebetween upon expansion of the expandable casing 14 by the expander 24.

After expanding the expandable casing 14 and removing the expander 24 from the wellbore 16 to provide a structure like that shown in FIG. 1F, the wellbore 16 may be prepared for production by, for example, perforating the casing 14 and/or the casing 18 at one or more locations along the wellbore 16 within producing regions of the formations. In additional embodiments, an additional section of the wellbore 16 may be drilled distal to the expanded casing 14 using another drill bit to drill through the remaining portions of the casing bit 10 at the distal end of the wellbore 16. As described in further detail below, the casing bit 10 may be configured to facilitate drilling therethrough by another drill bit. In some embodiments, another casing bit 10 and another section of expandable casing 14 having a relatively smaller outer diameter may be used to drill through the casing bit 10 shown in FIG. 1F, after which the other section of expandable casing 14 also may be expanded. This process may be repeated as desirable until the wellbore 16 reaches a desirable or limited depth.

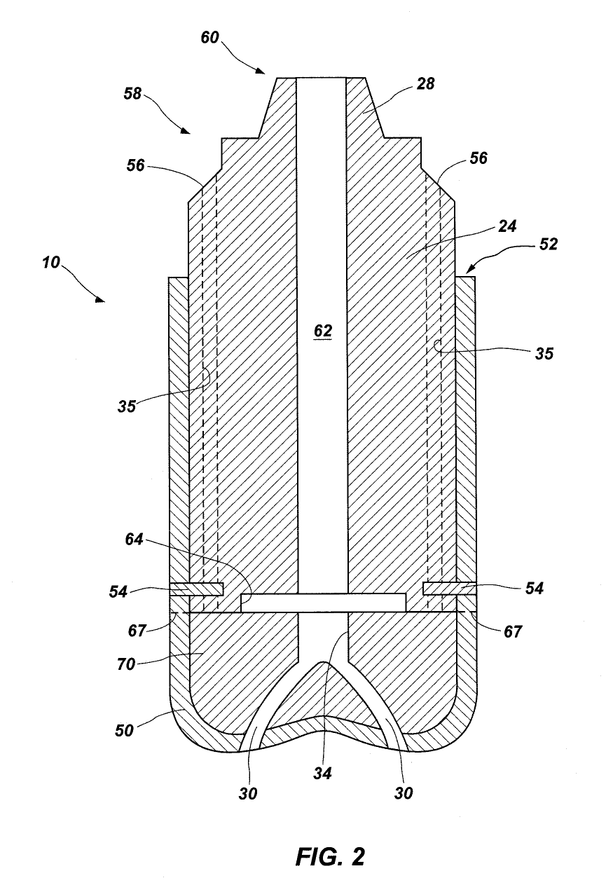

FIG. 2 is an enlarged, simplified, cross-sectional view of an embodiment of a casing bit 10 of the present invention that may be used to position expandable casing 14 within a wellbore 16, as previously discussed in relation to FIGS. 1A through 1F.

As shown in FIG. 2, the casing bit 10 has an outer bit body 50. The outer body 50 may comprise, for example, a metal alloy or a composite material having physical properties that include a strength sufficient to enable the casing bit 10 to be used for drilling, reaming, or both drilling and reaming, but that also allow the outer body 50 to be subsequently drilled through by another drill bit. A plurality of cutting structures for drilling and/or reaming may be provided on an exterior surface of the outer body 50, as described below, although such cutting structures are not illustrated in the simplified view of FIG. 2. By way of example and not limitation, the outer body 50 may comprise an outer body as described in U.S. patent application Ser. No. 11/747,651, which was filed May 11, 2007 and entitled “Reaming Tool Suitable For Running On Casing Or Liner And Method Of Reaming” (U.S. Patent Application Publication No. US 2007/0289782 A1, published Dec. 20, 2007), or as described in U.S. Pat. No. 7,395,882 B2, which issued on Jul. 8, 2008 to Oldham et al., each of which is incorporated herein in its entirety by this reference.

An expander 24 may be at least partially disposed within the outer body 50. In the embodiment of FIG. 2, the expander 24 is partially disposed within the outer body 50, but protrudes from a proximal end of the outer body 50. In other embodiments, the expander 24 may be substantially entirely disposed within the outer body 50, or the expander 24 may be disposed substantially entirely outside the outer body 50 and attached to a proximal end 52 of the outer body 50.

Optionally, the expander 24 may be attached to the outer body 50. As a non-limiting example, one or more shear pins 54 may be used to attach the expander 24 to the outer body 50. The shear pins 54 may extend at least partially through the outer body 50 and at least partially through the expander 24. The shear pins 54 may be sized and configured to shear apart (i.e., fail) when a predetermined force is applied between the expander 24 and the outer body 50 in the longitudinal direction, as occurs when the expander 24 begins to be forced through expandable casing 14 (FIGS. 1A-1F) to which the casing bit 10 is attached. To prevent the shear pins 54 from damaging the casing 14 as the expander is forced therethrough, the shear pins 54 may comprise a relatively soft metal alloy or a polymer material, and/or the shear pins 54 may be configured to fail at a location recessed relative to the outer surface of the expander. In yet further embodiments, the shear pins 54 could be disposed at other locations and orientations such that, upon failure of the shear pins 54, no portion of the shear pin 54 would rub against the casing 14 as the expander 24 is forced through the casing 14. In other embodiments, a snap ring, or another type of fastener, may be disposed between the inner surface of the outer body 50 and an exterior surface of the expander 24, and may be configured to be retained within the outer body 50 when sufficient force is applied between the expander 24 and the body 50 to longitudinally separate the same. In a broad sense, structure securing the expander 24 to the outer body 50 may be designed and configured to fail and permit release of expander 24 from the outer body responsive to at least one selected condition applied thereto. Such a condition may include, without limitation, tension, shear, torsion, compression and hydraulic pressure.

In additional embodiments, the expander 24 may not be fixedly attached to the outer body 50, and may simply be retained in position relative to the outer body 50 upon attachment of the casing bit 10 to the expandable casing 14 due to mechanical interference between the expander 24 and the outer body 50 and between the expander 24 and the expandable casing 14. In some embodiments, the expander 24 may be retained snugly so that the expander 24 is substantially restrained from longitudinal movement (e.g., in the distal or proximal directions). In other embodiments, the expander 24 may be retained with some amount of extra longitudinal space allowing the expander 24 to longitudinally separate from the outer body 50 to provide a net force acting on the expander 24 in the proximal longitudinal direction when a fluid is pressurized, as discussed below.

As previously described, the expander 24 may comprise a tapered, frustoconical surface 56 on a proximal end 58 of the expander 24 to facilitate the smooth, gradual expansion of the expandable casing 14 as the expander 24 is forced through the expandable casing 14 to expand the same. Furthermore, the expander 24 may comprise at least one feature 60 that may be matingly engaged by a string or pipeline (e.g., a drill string, coiled tubing, a parasitic string, a so-called “fishing string,” etc.). By way of example and not limitation, the feature 60 may comprise a threaded pin 28 provided on the proximal end 58 of the expander 24. As previously discussed, the threaded pin 28 may be configured to matingly engage a threaded box on a distal end of a string such as, for example, a pipeline 26. Also as previously discussed, it is contemplated that expander 24 may instead comprise a threaded box engageable by a threaded pin at a distal end of pipeline 26 by stabbing the pin into the box and rotating the pipeline. As another alternative, a stinger at the distal end of pipeline 26 may lockingly engage complementary structure of a receptacle at the proximal end of the expander 24, such complementary structures being known to those of ordinary skill in the art.

In some embodiments, the expander 24 may comprise a fluid passageway 62 that extends longitudinally through the expander 24. Furthermore, the expander 24 may have a shape configured to define at least one cavity 64 when the expander 24 is positioned within the casing bit 10. The cavity 64 may be located and shaped to allow fluid to flow into the cavity 64 from the fluid passageway 62 when fluid is pumped in the distal direction down through the expander 24 through the fluid passageway 62. The shape of the cavity 64 may be configured to provide a net force acting on the expander 24 in the proximal longitudinal direction when fluid within the fluid passageway 62 and the cavity 64 is pressurized. In some configurations of the casing bit 10, in the absence of such a cavity 64, such a net force might not result when the fluid passageway 62 is pressurized until at least some degree of longitudinal separation is attained between the expander 24 and the outer body 50. The expander 24 may also include one or more fluid ports 34 that extend longitudinally through the expander 24. These fluid ports 34 are located remote from the fluid passageway 62, and allow for fluid communication between the spaces within the wellbore above and below the expander 24 to allow fluid above the expander 24 to flow through the expander 24 through the fluid ports 34 to the space below the expander 24 as the expander 24 is forced upward through expandable casing in the wellbore.

With continued reference to FIG. 2, in some embodiments, the casing bit 10 may further comprise an inner body 70. The inner body 70 may comprise a separate body from the outer body 50. In such embodiments, the inner body 70 may comprise a material differing from a material of the outer body 50. For example, the material of the inner body 70 may comprise a metal alloy, a polymer material, or a composite material that is relatively softer and/or of lower strength relative to the outer body 50. The inner body 70 may not be subjected to the vigorous forces and stresses to which the outer body 50 is subjected during drilling, and, hence, it may be desirable to form the inner body 70 from a material that is relatively easier to subsequently drill through (relative to the outer body 50) using another drill bit.

In additional embodiments, however, the outer body 50 and the inner body 70 may simply be different regions of a common, integral (i.e., monolithic), substantially homogenous body formed of and comprising materials suitable for use as the outer body 50.

One or more fluid passageways 30 may extend through the casing bit 10 to allow fluid to be pumped through the expander 24 and out from the casing bit 10 through the fluid passageways 30 during a drilling process. A section of each of the fluid passageways 30 may extend through the inner body 70, and another section of each of the fluid passageways 30 may extend through the outer body 50. Each of the fluid passageways 30 may lead to, or pass through, a receptacle 34, as mentioned above, configured to receive a plug 32 (FIGS. 1C-1F) therein for plugging the fluid passageways 30. The plug 32 also may comprise a material that is relatively easy to subsequently drill through using another drill bit, but that has physical properties sufficient to plug the fluid passageways 30 and withstand the fluid pressure differential across the plug 32 that results upon pressurization of the space 37 (FIGS. 1D and 1E) distal to the expander 24 but proximal to the casing bit 10 when the expander 24 is being forced through expandable casing 14.

The casing bit 10 may be secured to a distal end 12 of a section of expandable casing 14 by, for example, welding the outer body 50 of the casing bit 10 to the distal end 12 of the expandable casing 14. In additional embodiments, complementary threads may be formed on the casing bit 10 and the distal end 12 of the expandable casing 14, and the casing bit 10 may be threaded to the distal end 12 of the expandable casing 14 to secure the casing bit 10 to the expandable casing 14. In such embodiments, the interface between the casing bit 10 and the expandable casing 14 optionally may be welded to further secure the casing bit 10 to the expandable casing 14 and threading the casing bit 10 to the expandable casing 14. Other methods such as, for example, brazing, also may be used to secure the casing bit 10 to the expandable casing 14.

In yet additional embodiments of the present invention, the expander 24 may be disposed between (e.g., located at least substantially entirely between) the casing bit 10 and the distal end 12 of the expandable casing 14. For example, a separate, additional sub (e.g., a generally tubular component comprising an inner cavity in which the expander 24 may be disposed) may be provided between the casing bit 10 and the distal end 12 of the expandable casing 14, and the expander 24 may be positioned within, and optionally secured within, the separate, additional sub. Referring to FIG. 2, the portion of the outer body 50 proximal to the dashed lines 67 shown therein may comprise a separate, additional sub in which the expander 24 may be disposed and secured. Such a separate, additional sub may be attached to the casing bit 10 at the location of the dashed lines 67 in manners like those previously described for attaching the distal end 12 of the expandable casing 14 to the casing bit 10 (e.g., one or more of welding, threading, brazing, etc.). The sub could also extend further in the proximal direction such that the expander 24 is at least substantially entirely contained within the sub.

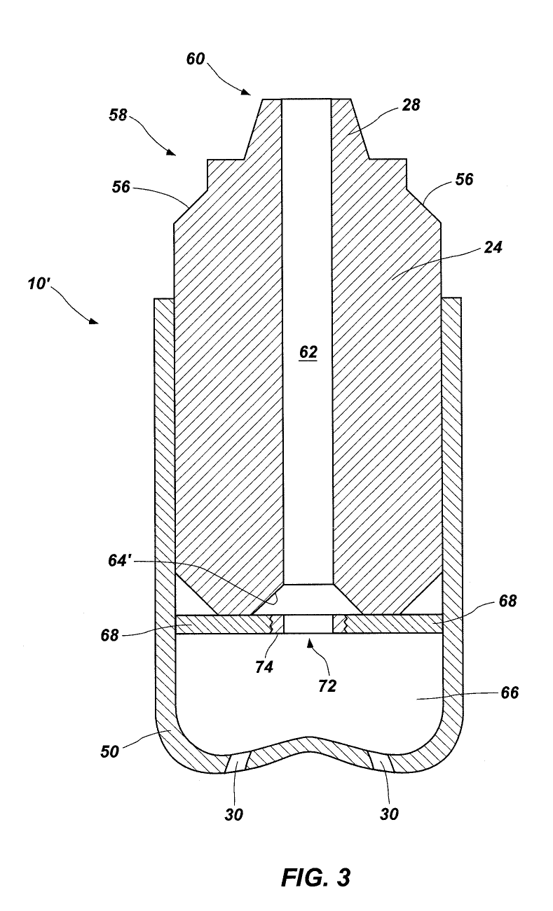

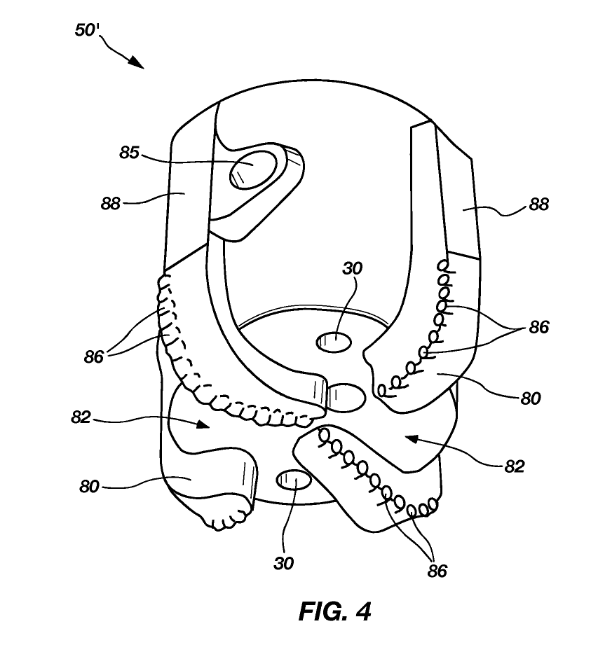

FIG. 3 is an enlarged, simplified, cross-sectional view of another embodiment of a casing bit 10′ of the present invention that may be used to position expandable casing 14 within a wellbore 16, as previously discussed in relation to FIGS. 1A through 1F.

As shown in FIG. 3, the casing bit 10′ is similar to the casing bit shown in FIG. 2 and includes an outer bit body 50 and an expander 24, as discussed hereinabove. However, the casing bit 10′ comprises a substantially hollow portion 66 inside of the bit body 50. The hollow portion 66 is bounded by the bit body 50 at the distal end and around the sides thereof, and by a plate 68 at a proximal end thereof. The plate 68 may comprise a separate body fixedly attached to the outer body 50. The plate 68 may be positioned so that a distal end of the expander 24 is adjacent a proximal side of the plate 68. The plate 68 may be fixedly attached to the outer body 50, for example, by welding the plate 68 to the outer body 50, using an adhesive, or other known means, as well as combinations thereof. In some embodiments, a shoulder may be formed on the inner surface of the body 50, such that the plate 68 may rest on the shoulder within the outer body 50. In such embodiments, the plate 68 also may be welded or otherwise attached to the outer body 50. The plate 68 may comprise a metal alloy, a polymer material, or a composite material that is relatively softer and/or of lower strength relative to the outer body 50. The material of the plate 68 may be selected so as to be sufficiently strong and erosion resistant to prevent the plate 68 from damage by hydraulic flow and pressure during drilling operations, but not too strong or wear resistant to prevent subsequent drilling through the plate 68 by another drill bit or tool, as previously discussed.

In additional embodiments, however, the outer body 50 and the plate 68 may simply be different regions of a common, integral (i.e., monolithic), substantially homogenous body formed of and comprising materials suitable for use as the outer body 50.

The plate 68 may have substantially planar sides in some embodiments. In other embodiments, one or both sides of the plate 68 may be non-planar. The plate 68 includes an aperture 72 that extends through a portion thereof. The aperture 72 allows fluid to be pumped through the expander 24 to the fluid passageways 30 during drilling. The aperture 72 may be configured to receive a plug (e.g., ball or dart) trap assembly 74 therein that is configured to receive a plug 32 (FIGS. 1C-1F) therein for plugging the hollow portion 66 and inhibiting flow to the hollow portion 66 and the fluid passageways 30. In some embodiments, the aperture 72 is threaded to receive a plug trap assembly 74 having complementary threads thereon. The plug 32 also may comprise a material that is relatively easy to subsequently drill through using another drill bit, but that has physical properties sufficient to plug the plug trap assembly 74 and withstand the fluid pressure differential across the plug 32 that results upon pressurization of the space 37 (FIGS. 1D and 1E) distal to the expander 24 but proximal to the plate 68 when the expander 24 is being forced through expandable casing 14.

One or more fluid passageways 30 may extend through the casing bit 10′ to allow fluid to be pumped through the expander 24 and the plate 68 and out from the casing bit 10′ through the fluid passageways 30 during a drilling process. A section of each of the fluid passageways 30 may extend through the outer body 50 and in communication with the hollow portion 66. During drilling, a drilling fluid may be pumped through the fluid passageway 62 and the aperture 72 into the hollow portion 66 and out through the fluid passageways 30.

As discussed above, the expander 24 may comprise a fluid passageway 62 that extends longitudinally through the expander 24 in some embodiments. Furthermore, the expander 24 may have a shape configured to define at least one cavity 64′ when the expander 24 is positioned within the casing bit 10′. The cavity 64′ may be located and shaped to allow fluid to flow into the cavity 64′ from the fluid passageway 62 when fluid is pumped in the distal direction down through the expander 24 through the fluid passageway 62. The shape of the cavity 64′ may be configured to provide a net force acting on the expander 24 in the proximal longitudinal direction when fluid within the fluid passageway 62 and the cavity 64′ is pressurized. In some configurations of the casing bit 10′, in the absence of such a cavity 64′, such a net force might not result when the fluid passageway 62 is pressurized until at least some degree of longitudinal separation is attained between the expander 24 and the plate 68.

The casing bit 10′ may be secured to a distal end 12 of a section of expandable casing 14 by, for example, welding the outer body 50 of the casing bit 10′ to the distal end 12 of the expandable casing 14. In additional embodiments, complementary threads may be formed on the casing bit 10′ and the distal end 12 of the expandable casing 14, and the casing bit 10′ may be threaded to the distal end 12 of the expandable casing 14 to secure the casing bit 10′ to the expandable casing 14. In such embodiments, the interface between the casing bit 10′ and the expandable casing 14 optionally may be welded to further secure the casing bit 10′ to the expandable casing 14 and threading the casing bit 10′ to the expandable casing 14. Other methods such as, for example, brazing, also may be used to secure the casing bit 10′ to the expandable casing 14.

FIG. 4 illustrates an embodiment of an outer body 50′ of a casing bit 10 (FIG. 2) of the present invention. A casing bit 10, 10′ comprising an outer body 50′ as shown in FIG. 4 comprises a casing drilling bit, and may be used to drill with expandable casing 14 attached thereto. The outer body 50′ may be formed of and comprise, for example, a metal or metal alloy (e.g., steel, aluminum, brass, or bronze), or a composite material including particles of a relatively harder material (e.g., tungsten carbide) embedded within a relatively softer metal or metal alloy (e.g., steel, aluminum, brass, or bronze). The material of the outer body 50′ may be selected to exhibit physical properties that allow the outer body 50′ to be drilled through by another drill bit after the casing bit 10 has been used to advance a section of expandable casing attached thereto into a subterranean formation.

Cutting structures may be provided on exterior surfaces of the outer body 50′. For example, the outer body 50′ may comprise a plurality of blades 80 that define fluid courses 82 therebetween. Fluid passageways 30 may be formed through the outer body 50′ or allowing fluid (e.g., drilling fluid and/or cement) to be pumped through the interior of the casing bit 10, 10′, out through the fluid passageways 30, and into the annulus between the wall of the formation in which the wellbore 16 is formed and the exterior surfaces of the casing bit 10, 10′ and the expandable casing 14 to which the casing bit 10, 10′ may be attached. Optionally, nozzles (not shown) may be secured to the outer body 50′ within the fluid passageways 30 to selectively tailor the hydraulic characteristics of the casing bit 10, 10′. Cutting element pockets may be formed in the blades 80, and cutting elements 86, such as, for example, polycrystalline diamond compact (PDC) cutting elements, may be secured within the cutting element pockets.

Also, each of blades 80 may include a gage region 88 that together define the largest diameter of the outer body 50′ and, thus, the diameter of any wellbore 16 formed using the outer body 50′ and the casing bit 10, 10′. The gage regions 88 may be longitudinal extensions of the blades 80. Wear resistant structures or materials may be provided on the gage regions 88. For example, tungsten carbide inserts, cutting elements, diamonds (e.g., natural or synthetic diamonds), or hardfacing material may be provided on the gage regions 88 of the outer body 50′.

In some instances, the size and placement of the fluid passageways 30 that are employed for drilling operations may not be particularly desired for cementing operations. Furthermore, the fluid passageways 30 may become plugged or otherwise obstructed during a drilling operation. As shown in FIG. 4, the outer body 50′ of the casing bit 10, 10′ may include one or more frangible regions 85 that can be breached (e.g., a metal disc that can be fractured, perforated, ruptured, removed, etc.) to form one or more additional apertures that may be used to provide fluid communication between the interior and the exterior of the outer body 50′. Drilling fluid and/or cement optionally may be caused to flow through such frangible regions 85 after breaching the same.

In additional embodiments, the outer body 50′ may not include blades 80 and cutting elements 86, like those shown in FIG. 4. Furthermore, the outer body 50′ may comprise other cutting structures such as, for example, deposits of hardfacing material (not shown) on the exterior surfaces of the outer body 50′. Such a hardfacing material may comprise, for example, hard and abrasive particles (e.g., diamond, boron nitride, silicon carbide, carbides or borides of titanium, tungsten, or tantalum, etc.) embedded within a metal or metal alloy matrix material (e.g., an iron-based, cobalt-based, or nickel-based metal alloy).

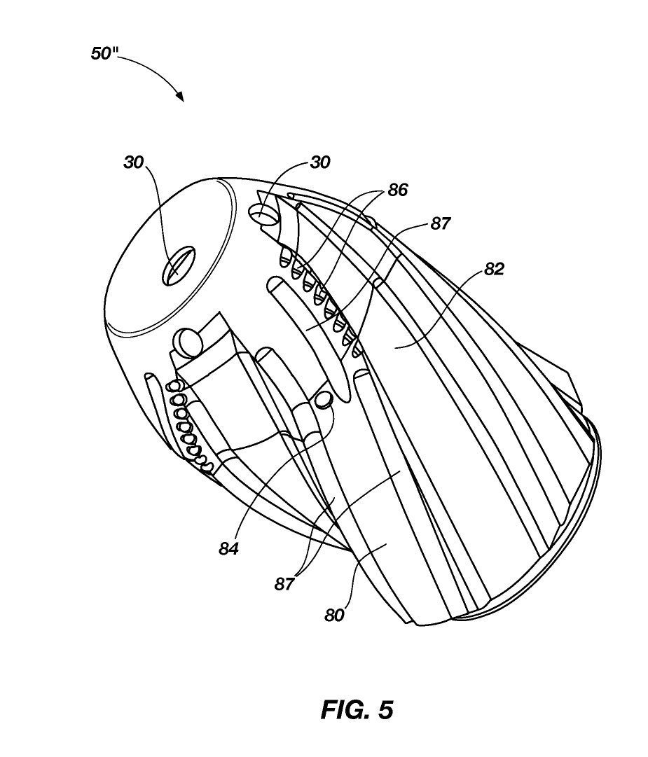

FIG. 5 illustrates another example embodiment of an outer body 50″ of a casing bit 10, 10′ (FIGS. 2 and 3) of the present invention. A casing bit 10, 10′ comprising an outer body 50″ as shown in FIG. 5 comprises a casing reaming bit, and may be used to ream a previously drilled wellbore 16 as the casing reaming bit is advanced into the wellbore 16 on a distal end of expandable casing 14. The outer body 50″ may be generally similar to the outer body 50′ of FIG. 4, and may comprise a plurality of blades 80 that define fluid courses 82 therebetween. Fluid passageways 30 may be formed through the outer body 50″ or allowing fluid (e.g., drilling fluid and/or cement) to be pumped through the interior of the casing bit 10, 10′, out through the fluid passageways 30, and into the annular space between the walls of the formation in which the wellbore 16 is formed and the exterior surfaces of the casing bit 10, 10′ and the expandable casing 14 to which the casing bit 10, 10′ may be attached. Cutting element pockets may be formed in the blades 80, and cutting elements 86, such as, for example, polycrystalline diamond compact (PDC) cutting elements, may be secured within the cutting element pockets. In additional embodiments, the outer body 50″ may not include blades 80 and cutting elements 86, like those shown in FIG. 5. Furthermore, the outer body 50″ may comprise other cutting structures such as, for example, deposits of hardfacing material 87 on the exterior surfaces of the outer body 50″. Such a hardfacing material may comprise, for example, hard and abrasive particles (e.g., diamond, boron nitride, silicon carbide, carbides or borides of titanium, tungsten, or tantalum, etc.) embedded within a metal or metal alloy matrix material (e.g., an iron-based, cobalt-based, or nickel-based metal alloy). Wear-resistant bearing elements 84 such as, for example, tungsten carbide ovoids, also may be provided on exterior surfaces of the outer body 50″.

Although the foregoing description contains many specifics, these are not to be construed as limiting the scope of the present invention, but merely as providing certain embodiments. Similarly, other embodiments of the invention may be devised which do not depart from the scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

1. A casing bit, comprising:
a body having an outer surface;
at least one cutting element carried over the outer surface of the body; and
an expander disposed at least proximate the body, the expander sized and configured to expand expandable casing secured to the casing bit as the expander is forced longitudinally therethrough.

2. The casing bit of claim 1, wherein the body comprises an outer body and a separate inner body disposed within the outer body, the inner body comprising a material having at least one of a hardness lower than a hardness of the outer body and a strength lower than a strength of the outer body.

3. The casing bit of claim 2, further comprising at least one fluid passageway extending through the outer body and the inner body.

4. The casing bit of claim 3, wherein the at least one fluid passageway extends to a receptacle sized and configured to receive a plug therein for plugging the at least one fluid passageway.

5. The casing bit of claim 1, wherein the body comprises an outer body and a plate disposed within the outer body and forming a proximal boundary to a substantially hollow portion of the body, the plate comprising an aperture therethrough.

6. The casing bit of claim 5, further comprising a plug trap assembly secured in the aperture of the plate.

7. The casing bit of claim 5, wherein the expander has a shape configured to define at least one cavity when the expander is at least partially disposed within the body, the at least one cavity configured to initiate a net force between the expander and the plate when fluid within the at least one cavity is pressurized for separating the expander from the plate.

8. The casing bit of claim 1, wherein the expander comprises a generally cylindrical, tubular body having an outer surface, at least a portion of the outer surface having a substantially frustoconical shape sized and configured to expand the expandable casing as the expander is forced longitudinally therethrough.

9. The casing bit of claim 1, wherein the expander has a shape configured to define at least one cavity when the expander is at least partially disposed within the body, the at least one cavity configured to initiate a net force between the expander and the body when fluid within the at least one cavity is pressurized for separating the expander from the body.

10. The casing bit of claim 1, wherein the expander is fixedly attached to the body.

11. The casing bit of claim 10, wherein the expander is fixedly attached to the body with structure configured to detach the expander from the body responsive to at least one selected condition applied thereto.

12. The casing bit of claim 1, wherein the body and the at least one cutting element are cooperatively configured for at least one of drilling and reaming a wellbore.

13. A drilling assembly, comprising:
at least one section of expandable casing;
a casing bit attached to a distal end of the at least one section of expandable casing, the casing bit comprising:
a body having an outer surface; and
at least one cutting element on the outer surface of the body; and
an expander disposed in proximity to the casing bit and the distal end of the at least one section of expandable casing, the expander sized and configured to expand the at least one section of expandable casing as the expander is forced longitudinally through the at least one section of expandable casing.

14. The drilling assembly of claim 13, wherein the casing bit comprises a receptacle sized and configured to receive a plug therein for plugging at least one fluid passageway extending through the casing bit.

15. The drilling assembly of claim 14, wherein the expander comprises a generally cylindrical, tubular body having an outer surface, at least a portion of the outer surface having a substantially frustoconical shape sized and configured to expand the at least one section of the expandable casing as the expander is forced longitudinally therethrough.

16. The drilling assembly of claim 15, wherein the expander is at least partially disposed within the body of the casing bit, and wherein the expander has a shape configured to define at least one cavity when the expander is at least partially disposed within the body of the casing bit, the at least one cavity configured to result in a net force between the expander and the body of the casing bit for separating the expander from the body of the casing bit when a fluid within the at least one cavity is pressurized.

17. The drilling assembly of claim 13, wherein the casing bit comprises a plate attached to the body and defining a proximal boundary of a substantially hollow portion of the body, the plate comprising an aperture therethrough.

18. The drilling assembly of claim 17, wherein the expander is at least partially disposed within the body, and wherein the expander has a shape configured to define at least one cavity when the expander is at least partially disposed within the body, the at least one cavity configured to result in a net force between the expander and the plate for separating the expander from the plate when fluid within the at least one cavity is pressurized.

19. The drilling assembly of claim 13, wherein the casing bit is welded to the distal end of the at least one section of expandable casing.

20. A method of forming a casing bit, comprising:
configuring an expander to enlarge at least an inner diameter of expandable casing as the expander is forced therethrough; and
positioning the expander at least partially within a body of a casing bit.

21. The method of claim 20, wherein configuring the expander to enlarge at least an inner diameter of expandable casing as the expander is forced therethrough comprises forming a tapered, frustoconical surface on a proximal end of the expander.

22. The method of claim 20, wherein configuring the expander comprises forming at least one feature configured to be matingly engaged by a string or pipeline.

23. The method of claim 22, wherein forming the at least one feature comprises forming a threaded pin on a proximal end of the expander.

24. The method of claim 20, wherein positioning the expander at least partially within a body of a casing bit comprises fixedly attaching the expander to the body of the casing bit.

25. The method of claim 24, wherein fixedly attaching the expander to the body of the casing bit comprises inserting at least one shear pin at least partially through the expander and at least partially through the body of the casing bit.

26. The method of claim 20, wherein positioning the expander at least partially within the body of the casing bit comprises positioning the expander adjacent one of an inner body and a plate partially defining a substantially hollow portion of the body.

27. A method of forming a drilling assembly, comprising:
positioning an expander configured to enlarge at least an inner diameter of expandable casing as the expander is forced therethrough proximate a body of a casing bit and an adjacent end of a section of expandable casing; and
attaching the body of the casing bit to the adjacent end of the section of expandable casing.

28. The method of claim 27, wherein positioning an expander proximate a body of a casing bit and an adjacent end of a section of expandable casing comprises:
positioning the expander at least partially within the body of the casing bit; and
fixedly attaching the expander to the body of the casing bit.

29. The method of claim 27, wherein positioning an expander proximate a body of a casing bit and an adjacent end of a section of expandable casing comprises positioning the expander between the body of the casing bit and the expandable casing.

30. The method of claim 27, wherein the expander is retained by mechanical interference between the expander and the body of the casing bit and between the expander and the expandable casing when the body of the casing bit is attached to the adjacent end of the section of expandable casing.

31. A method of casing a wellbore, comprising:
at least one of drilling and reaming a wellbore using a casing bit attached to a distal end of at least one section of expandable casing;
forcing an expander disposed in proximity to the casing bit and the distal end of the at least one section of expandable casing longitudinally through the at least one section of expandable casing in a proximal direction to enlarge at least an inner diameter of at least a portion of the at least one section of expandable casing as the expander is forced longitudinally therethrough.

32. The method of claim 31, wherein forcing the expander disposed in proximity to the casing bit and the distal end of the at least one section of expandable casing longitudinally through the at least one section of expandable casing in a proximal direction comprises:
pumping a hydraulic fluid into a cavity defined by the expander; and
effecting a net force in a proximal longitudinal direction.

33. The method of claim 32, wherein pumping a hydraulic fluid into a cavity defined by the expander comprises pumping a hydraulic fluid into a cavity between the expander and an inner body of the casing bit.

34. The method of claim 32, wherein pumping a hydraulic fluid into a cavity defined by the expander comprises pumping a hydraulic fluid into a cavity between the expander and a plate coupled to the casing bit.

35. The method of claim 31, wherein forcing the expander disposed in proximity to the casing bit and the distal end of the at least one section of expandable casing longitudinally through the at least one section of expandable casing in a proximal direction comprises shearing apart at least one shear pin extending at least partially through the casing bit and at least partially through the expander.
